(19) United States
(12) Patent Application Publication
(10) Pub. No.: US 2012/0179540 A1
(43) Pub. Date: Jul. 12, 2012

(54) METHOD OF FINDING COMMONALITIES WITHIN A DATABASE

(76) Inventors: Samuel Michaels, New York, NY (US); David I. Michaels, Los Angeles, CA (US)

(21) Appl. No.: 13/004,980

(22) Filed: Jan. 12, 2011

(51) Int. Cl. G06F 17/30; G06Q 30/00

(52) U.S. Cl. 705/14.49; 707/769; 707/722; 707/728; 707/E17.005; 707/E17.014

(57) ABSTRACT

A computer implemented method of finding commonalities among search terms within an electronic database, comprises the steps of: receiving at least two search terms from a user; performing an individual computerized search within the electronic database for each of the at least two search terms; generating a plurality of individual results for each of the at least two search terms; identifying at least one commonality mutually shared by at least two of the plurality of individual results; and presenting the at least one commonality. The at least one commonality can comprise a plurality of commonalities which can be ranked based on the number of search terms with which the commonality is associated, where the commonality associated with the greatest number of search terms is ranked highest. The ranking can be further based on frequency of the commonality across all individual results, link distance or other standard measures of commonality.

### FIELD OF THE INVENTION

The present invention generally relates to searching databases. More particularly, the present invention relates to a method of finding unknown and unidentified commonalities among search terms within a database.

### BACKGROUND OF THE INVENTION

A web search engine is designed to search for information on the World Wide Web and FTP servers. The search results are generally presented as a list of results and are often called hits. The information may consist of web pages, images, information and other types of files. Some search engines also mine data available in databases or open directories. Unlike Web directories, which are maintained by human editors, search engines operate algorithmically or are a mixture of algorithmic and human input.

During the early development of the World Wide Web, there was a list of webservers edited and controlled by individual people. As more webservers went online this central list could not keep up and track all the new webservers. As a solution to this problem, the very first tool used for searching on the Internet was Archie. The name stands for “archive” without the “v.” It was created in 1990 by computer science students at McGill University in Montreal. The program downloaded the directory listings of all the files located on public anonymous FTP (File Transfer Protocol) sites, creating a searchable database of file names. However, Archie did not index the contents of these sites since the amount of data was so limited it could be readily searched manually.

The rise of Gopher in 1991 led to two new search programs, Veronica and Jughead. Like Archie, they searched the file names and titles stored in Gopher index systems. Veronica (Very Easy Rodent-Oriented Net-wide Index to Computerized Archives) provided a keyword search of most Gopher menu titles in the entire Gopher listings. Jughead (Jonzy's Universal Gopher Hierarchy Excavation And Display) was a tool for obtaining menu information from specific Gopher servers. (While the name of the search engine “Archie” was not a reference to the Archie comic book series, “Veronica” and “Jughead” are characters in the series, thus referencing their predecessor.)

In the summer of 1993, no search engine existed yet for the web, though numerous specialized catalogues were maintained by hand. Oscar Nierstrasz at the University of Geneva wrote a series of Perl scripts that would periodically mirror these pages and rewrite them into a standard format which formed the basis for W3Catalog, the web's first primitive search engine, released on Sep. 2, 1993. In June 1993, Matthew Gray, then at MIT, produced what was probably the first web robot, the Perl-based World Wide Web Wanderer, and used it to generate an index called ‘Wandex’. The purpose of the Wanderer was to measure the size of the World Wide Web, which it did until late 1995. The web's second search engine Aliweb appeared in November 1993. Aliweb did not use a web robot, but instead depended on being notified by website administrators of the existence at each site of an index file in a particular format.

JumpStation (released in December 1993) used a web robot to find web pages and to build its index, and it used a web form as the interface to its query program. It was thus the first WWW resource-discovery tool to combine the three essential features of a web search engine (crawling, indexing, and searching) as described below. Because of the limited resources available on the platform on which it ran, its indexing and hence searching were limited to the titles and headings found in the web pages the crawler encountered.

One of the first “full text” crawler-based search engines was WebCrawler, which came out in 1994. Unlike its predecessors, it let users search for any word in any webpage, which has become the standard for all major search engines since. It was also the first one to be widely known by the public. Also in 1994, Lycos (which started at Carnegie Mellon University) was launched and became a major commercial endeavor.

Soon after, many search engines appeared and vied for popularity. These included Magellan, Excite, Infoseek, Inktomi, Northern Light, and AltaVista. Yahoo! was among the most popular ways for people to find web pages of interest, but its search function operated on its web directory, rather than full-text copies of web pages. Information seekers could also browse the directory instead of doing a keyword-based search.

In 1996, Netscape was looking to give a single search engine an exclusive deal to be their featured search engine. There was so much interest that instead a deal was struck with Netscape by five of the major search engines, where for $5 million per year each search engine would be in a rotation on the Netscape search engine page. The five engines were Yahoo!, Magellan, Lycos, Infoseek, and Excite.

Search engines were also known as some of the brightest stars in the Internet investing frenzy that occurred in the late 1990s. Several companies entered the market spectacularly, receiving record gains during their initial public offerings. Some have taken down their public search engine, and are marketing enterprise-only editions, such as Northern Light. Many search engine companies were caught up in the dot-com bubble, a speculation-driven market boom that peaked in 1999 and ended in 2001.

Around 2000, the Google search engine rose to prominence. The company achieved better results for many searches with an innovation called PageRank. This iterative algorithm ranks web pages based on the number and PageRank of other web sites and pages that link there, on the premise that good or desirable pages are linked to more than others. Google also maintained a minimalist interface to its search engine. In contrast, many of its competitors embedded a search engine in a web portal.

By 2000, Yahoo was providing search services based on Inktomi's search engine. Yahoo! acquired Inktomi in 2002, and Overture (which owned AlltheWeb and AltaVista) in 2003. Yahoo! switched to Google's search engine until 2004, when it launched its own search engine based on the combined technologies of its acquisitions.

Microsoft first launched MSN Search in the fall of 1998 using search results from Inktomi. In early 1999 the site began to display listings from Looksmart blended with results from Inktomi except for a short time in 1999 when results from AltaVista were used instead. In 2004, Microsoft began a transition to its own search technology, powered by its own web crawler (called msnbot). Microsoft's rebranded search engine, Bing, was launched on Jun. 1, 2009. On Jul. 29, 2009, Yahoo! and Microsoft finalized a deal in which Yahoo! Search would be powered by Microsoft Bing technology.

A search engine operates, in the following order by (1) Web crawling, (2) indexing, and (3) searching. Web search engines work by storing information about many web pages, which they retrieve from the html itself. These pages are retrieved by a Web crawler (sometimes also known as a spider)—an automated Web browser which follows every link on the site. The contents of each page are then analyzed to determine how it should be indexed (for example, words are extracted from the titles, headings, or special fields called metatags). Data about web pages are stored in an index database for use in later queries. A query can be a single word. The purpose of an index is to allow information to be found as quickly as possible.

Some search engines, such as Google, store all or part of the source page (referred to as a cache) as well as information about the web pages, whereas others, such as AltaVista, store every word of every page they find. This cached page always holds the actual search text since it is the one that was actually indexed, so it can be very useful when the content of the current page has been updated and the search terms are no longer in it. This problem might be considered to be a mild form of linkrot, and Google's handling of it increases usability by satisfying user expectations that the search terms will be on the returned webpage. This satisfies the principle of least astonishment since the user normally expects the search terms to be on the returned pages. Increased search relevance makes these cached pages very useful, even beyond the fact that they may contain data that may no longer be available elsewhere. When a user enters a query into a search engine (typically by using key words), the engine examines its index and provides a listing of best-matching web pages according to its criteria, usually with a short summary containing the document's title and sometimes parts of the text. The index is built from the information stored with the data and the method by which the information is indexed. Unfortunately, there are currently no known public search engines that allow documents to be searched by date.

Some search engines provide an advanced feature called proximity search which allows users to define the distance between keywords. There is also concept-based searching where the research involves using statistical analysis on pages containing the words or phrases you search for. As well, natural language queries allow the user to type a question in the same form one would ask it to a human; such a site like this would be ask.com.

The usefulness of a search engine depends on the relevance of the result set it gives back. While there may be millions of web pages that include a particular word or phrase, some pages may be more relevant, popular, or authoritative than others. Most search engines employ methods to rank the results to provide the “best” results first. How a search engine decides which pages are the best matches, and what order the results should be shown in, varies widely from one engine to another. The methods also change over time as Internet usage changes and new techniques evolve. There are two main types of search engine that have evolved: one is a system of predefined and hierarchically ordered keywords that humans have programmed extensively. The other is a system that generates an “inverted index” by analyzing texts it locates. This second form relies much more heavily on the computer itself to do the bulk of the work.

Most Web search engines are commercial ventures supported by advertising revenue and, as a result, some employ the practice of allowing advertisers to pay money to have their listings ranked higher in search results. Those search engines which do not accept money for their search engine results make money by running search related ads alongside the regular search engine results. The search engines make money every time someone clicks on one of these ads.

As can be seen, many have attempted to improve the searching functionality of search engines. For instance, some search engines combine the search results of a keyword with a user defined commonality to yield more relevant results. Sometimes, the keyword searched is replaced with a better keyword or commonality that will result in more relevant hits. The commonality used is measured and determined from a user's prior searches, a user's re-ranking of prior search results, other groups of user searches, other groups of search results, predefined categories, or a user's or advertisers physical location.

However, existing search engines, strategies, and technologies do not allow users to search for an unknown common thread/commonality between groups of chosen search terms. Existing search engines employ complex algorithms to infer what the users intend to search. These algorithms must be able to adjust for the nuances and imperfections of natural language and guess the context in which words are being used, in order to offer the best search results. As identified above, measures of commonality are sometimes used to improve upon the efficiency of the search and the quality of the results; for example to search one or more terms' commonality against a plurality of categories of information to offer a more relevant single list of results. Current search technologies, however, do not allow users to explicitly search and sort for unknown commonalities (i.e. common threads) between a preselected plurality of search terms (i.e. people, places, things, ideas, profiles, etc). Said differently, existing search technologies sometimes use commonalities to find relevant search results, but do not allow users to search a database, or use search results lists to find and sort common themes themselves.

Furthermore, existing search technologies can only retrieve a commonality between multiple search terms to the extent that the commonality was already made explicit within the database—what is referred to as a “Direct Commonality.” For example, an Internet search engine can help find the commonality between the two search terms “George Washington” and “Woodrow Wilson” because both terms exist on the same web page(s) (e.g., lists of U.S. Presidents). These two search terms are therefore separated by 0 degrees, and “Presidency” was the Direct Commonality. Current search technologies, however, are not designed to find commonalities that are 1 or more degrees separated—what are now referred to as “Indirect Commonalities.” For example, if there is a web page describing George Washington chopping down a cherry tree and another web page mentioning Woodrow Wilson's favorite fruit as cherries, then a single search for “‘Woodrow Wilson’ and ‘George Washington’” might not retrieve both web pages. Even if both pages are retrieved, since both web pages are not equally relevant to both search terms, each web page will come up at different points in the list—which, for most modern search engines, typically contain millions of results—making it virtually impossible for a user to find both articles relating to cherries which is an Indirect Commonality between the two search terms.

Existing profile matching technologies (dating websites and social networks) use commonalities to sort user profiles, but are not designed to identify and sort the commonalities within a user-defined group of profiles. When comparing profiles on an existing dating website or social network, a user can find profiles by searching descriptive fields directly, or by sorting profiles based on overall commonality of descriptive fields. However, there is no way for a user to pre-select a combination of profiles, and then run a search which lists and sorts the commonalities that the group happens to possess. For example a user can search a social network for other members of the social network who like the movie “Titanic.” But there is no way to select a group of profiles to discover that the movie “Titanic” happens to be the third most common theme within the group. This would be particularly useful if the user did not already know that this movie was common to the group prior to running a search.

Accordingly, there is a need for a method of finding unknown/unidentified commonalities among search terms within a database. The present invention fulfills these needs and provides other related advantages.

### SUMMARY OF THE INVENTION

An exemplary embodiment of the present invention will first execute discrete searches for all search terms the user inputs. Second, it will discard the discrete search results for each term that have no commonality to the discrete results for other terms. Finally, it will identify and rank the results in order of commonality. Continuing with the earlier hypothetical example, an exemplary embodiment of the invention will first execute a discrete search for both “Woodrow Wilson” and “George Washington.” Second, it will discard the results that don't have a commonality between the two lists, even though they may be the most relevant results for each individual term. Finally, it will find that the keyword “Cherry” appears on two separate web pages in each list. Both links will be returned to the user in one row that highlights the Indirect Commonality (in this case “Cherry”). Furthermore, additional links to pages related to the common theme Cherry, will be grouped into this row, as they all relate to the same Indirect Commonality. Thus, whereas existing search technologies require a user to have an idea of what he or she is looking for in advance of executing the search, this invention requires the user only to have an idea of a group of terms he/she seeks to find a commonality between, but not an idea of what direct and indirect commonalities will emerge from the search.

Furthermore, existing advertising sales placement technologies do not allow advertisers to bid for or buy advertisements for commonalities on a one-to-one basis. Existing advertising sales placement technology currently uses various forms of commonality measures to sell a plurality of advertisements against one search results list. For example, a plurality of advertisers buying a plurality of keyword commonalities will jointly sponsor a single search result list. An exemplary embodiment of the present invention allows advertisers to bid for the exclusive sponsorship of discrete commonalities. The present invention is a more attractive advertising platform than traditional search technologies because users of this technology may be inherently more open to clicking on a sponsored link. Since users of traditional search engines must have an idea of what they are searching for prior to the execution of their search, they are more focused, and thus, less likely to invite a sponsored link or advertisement. By comparison, users of this technology can not have a preconceived notion of what they are searching for. As such, they may be relatively open to viewing sponsored results, which may help offer the user more relevant information relating newly revealed common threads.

In an exemplary embodiment of the present invention, a computer implemented method of finding commonalities among search terms within an electronic database, comprises the steps of: receiving, via a computing device, at least two search terms from a user; performing, via the computing device, an individual computerized search within the electronic database for each of the at least two search terms; generating, via the computing device, a plurality of individual results for each of the at least two search terms; identifying, via the computing device, at least one commonality mutually shared by at least two of the plurality of individual results; and presenting, via the computing device, to the user the at least one commonality. Another exemplary embodiment may further comprise the step of removing all individual results from the plurality of individual results lacking the at least one commonality, or alternatively, to not display the individual results from the plurality of individual results lacking the at least one commonality.

The electronic database can comprise a closed or open database. The closed database limits user entries to pre-defined fields and can include a local database, an email server, a corporate directory, a closed social network, a research database, or an intranet. The open database allows user-defined fields and can include the Internet or an open social network. Furthermore, the electronic database can comprise both an open database and a closed database.

An exemplary embodiment can further comprise the step of excluding all non-informative commonalities from the at least one commonality. For example, non-informative commonalities can include, but are not limited to, the words, “the,” “and,” and “but.” These words do not add any context or information to the search and should be excluded as commonalities.

The at least one commonality can comprise a plurality of commonalities. Furthermore, an exemplary embodiment can comprise the step of ranking the plurality of commonalities. The ranking the plurality of commonalities can be based on the number of search terms with which the commonality is associated, where the commonality associated with the greatest number of search terms is ranked highest. The ranking the plurality of commonalities can be further based on a frequency of the commonality across all individual results, where the commonality repeated with the greatest frequency is ranked highest. The ranking the plurality of commonalities can be further based on a link distance—the number of links it takes to navigate from one web page to another—where the commonality with the smallest link distance is ranked highest.

In another exemplary embodiment, the step of presenting the at least one commonality to the user comprises displaying each of the at least two search terms as column headers. Presenting the at least one commonality to the user can further comprise displaying each of the at least one commonality as row headers. Presenting the at least one commonality to the user can further comprise displaying each of the plurality of individual results below its corresponding column header (search term) and adjacent to its corresponding row header (commonality).

Another exemplary embodiment can comprise receiving an additional search term from a user after a first predetermined keyboard shortcut to benefit user convenience and search efficiency. The first predetermined keyboard shortcut can comprise a double space. Furthermore, an exemplary embodiment can comprise the step of removing the additional search term after a second predetermined keyboard shortcut. The second predetermined keyboard shortcut can comprise a double backspace.

In another exemplary embodiment the database can comprise the Internet wherein the plurality of individual results for each of the at least two search terms can comprise hidden descriptive identifiers. The hidden descriptive identifiers can comprise metatext. Furthermore, an exemplary embodiment can comprise the step of ranking the plurality of commonalities from the individual results based on the metatext, where the metatext repeated with the greatest frequency is ranked highest. The presenting step can further comprise providing information associated with the at least one commonality including an accessible web address, or other web page summary text.

In another exemplary embodiment, the at least one of the at least two search terms can be a predefined group.

Another exemplary embodiment can further comprise the step of removing a particular commonality from the plurality of commonalities, the removed commonality corresponding to a user-defined restriction term.

Another exemplary embodiment can further comprise the step of re-sorting the ranking of the plurality of commonalities based upon a manual re-sorting of the rankings by the user. The user can manually re-sort the rankings by dragging a particular commonality higher or lower in ranking.

Another exemplary embodiment can further comprise the step of manually removing a particular commonality from the plurality of commonalities.

Another exemplary embodiment can further comprise the step of providing a sponsored advertisement or product placement associated with the at least one commonality or a group of commonalities.

The sponsored advertisement can be determined by the highest bidder. Relevant advertisements can be placed along side each commonality, or group of commonalities or the commonalities can themselves contain links to sponsored advertisements.

In yet another exemplary embodiment of the present invention, a computer-readable medium having computer-readable instructions stored thereon which, which executed by a computer, can cause the computer to perform a method of finding commonalities among search terms within an electronic database. The steps comprise: receiving, through the computer, at least two search terms from a user; performing, through the computer, an individual computerized search within an electronic database for each of the at least two search terms; generating, through the computer, a plurality of individual results for each of the at least two search terms; identifying, through the computer, at least one commonality mutually shared by at least two of the plurality of individual results; and presenting, through the computer, to the user the at least one commonality.

In another exemplary embodiment, the at least one commonality can comprise a plurality of commonalities. The plurality of commonalities can be ranked. The step of ranking the plurality of commonalities can based on the number of search terms with which the commonality is associated, where the commonality associated with the greatest number of search terms is ranked highest. The step of ranking the plurality of commonalities is further based on a frequency of the commonality across all individual results, where the commonality repeated with the greatest frequency is ranked highest. The step of ranking the plurality of commonalities is further based on a link distance, where the commonality with the smallest link distance is ranked highest. An exemplary embodiment can further comprise the step of removing a particular commonality from the plurality of commonalities, the removed commonality corresponding to a user-defined restriction term.

In yet another exemplary embodiment of the present invention, a computing device can be configured to perform operations. The operations can comprise: receiving, through the computing device, at least two search terms from a user; performing, through the computing device, an individual computerized search within an electronic database for each of the at least two search terms; generating, through the computing device, a plurality of individual results for each of the at least two search terms; identifying, through the computing device, a plurality of commonalities mutually shared by at least two of the plurality of individual results; and presenting, through the computing device, to the user the at least one commonality.

An exemplary embodiment can further comprise ranking, through the computing device, the plurality of commonalities wherein the ranking the plurality of commonalities is based on the number of search terms with which the commonality is associated, where the commonality associated with the greatest number of search terms is ranked highest. The ranking the plurality of commonalities can be further based on a frequency of the commonality across all individual results, where the commonality repeated with the greatest frequency is ranked highest. The ranking the plurality of commonalities can be further based on a link distance, where the commonality with the smallest link distance is ranked highest. The ranking the plurality of commonalities can be further based on other standard measures of commonality, including natural language, lexical or other statistical methods. An exemplary embodiment can further comprise removing, through the computing device, a particular commonality from the plurality of commonalities wherein the removed commonality corresponds to a user-defined restriction term.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1A is a view of an exemplary search engine embodying the present invention;

FIG. 1B is a view similar to FIG. 1A now showing a second input field;

FIG. 1C is a view similar to FIG. 1A now showing four input fields;

FIG. 2 is representational view of the logic steps used embodying the present invention based on the inputs from FIG. 1C;

FIG. 3 is another representational view of the logic steps embodying the present invention within an Open Database;

FIG. 4 is an exemplary search results embodying the present invention based on the inputs from FIG. 2;

FIG. 5 is another exemplary Open Database search results embodying the present invention associated with inputs of FIG. 3;

FIG. 6 is a block diagram of the method of using the present invention according to FIGS. 1A-1C;

FIG. 7 is a block diagram of the method of using the present invention according to FIG. 2;

FIG. 8 is a block diagram of the method of using the present invention according to FIG. 3; and

FIG. 9 is another block diagram of the method of using the present invention featuring advertisements, as shown in FIGS. 4 and 5.

### DETAILED DESCRIPTION OF THE PREFERRED EMBODIMENTS

Electronic searching for information contained in a database is typically conducted by entering a query term or phrase into a search engine. Typically, the search query returns document results that are based on relevancy to the queried search term(s). The term documents, as used in this application encompasses files, records, pages, Internet sites, data entries, or any other terminology used to identify a unit of a database. With the growing use of the Internet and database technologies, query based searching has grown beyond simply searching databases contained locally within an organization, to searching file systems and external databases over the Internet due to its vast resources and wealth of information.

While search engines are most well known in the context of the Internet, their usefulness is much broader. Search engines may be used in other large networks, such as internal corporate or organizational networks (i.e., Intranets). Furthermore, search engines may be used to search the contents of various databases or other storage elements, even the hard drives of personal computers. For instance, an individual email address present on an email or meeting request can be associated with a corporate or social networking database. The present invention allows for commonality searches within the email/meeting planner program, as a way to identify a commonality between all users on the email or meeting. Most of the description below is made in reference to the Internet. However, a person of skill in the art would readily recognize that the teachings below are applicable generally to search engines regardless of the medium/database being searched. A database can include a local database, an email server, a corporate directory, a social network, a research database, the Internet or any combination thereof.

An exemplary embodiment of the present invention will first execute discrete searches for all search terms the user inputs. Second, it will discard the discrete search results for each term that has no commonality to the discrete results for other terms. Finally, it will identify and rank the results in order of commonality. Continuing with the earlier hypothetical example, an exemplary embodiment of the invention will first execute a discrete search for both “Woodrow Wilson” and “George Washington.” Second, it will discard the results that don't have a commonality between the two lists, even though they may be the most relevant results for each individual term. Finally, it will find that the keyword “Cherry” appears on two separate web pages in each list. Both links will be returned to the user in one row that highlights the Indirect Commonality (in this case “cherry”). Furthermore, additional links to pages related to the common theme Cherry, will be grouped into this row, as they all relate to the same Indirect Commonality. Thus, whereas existing search technologies require a user to have an idea of what he or she is looking for in advance of executing the search, the present invention requires the user only to have an idea of a group of terms he/she seeks to find a commonality between, but not an idea of what direct and indirect commonalities will emerge from the search.

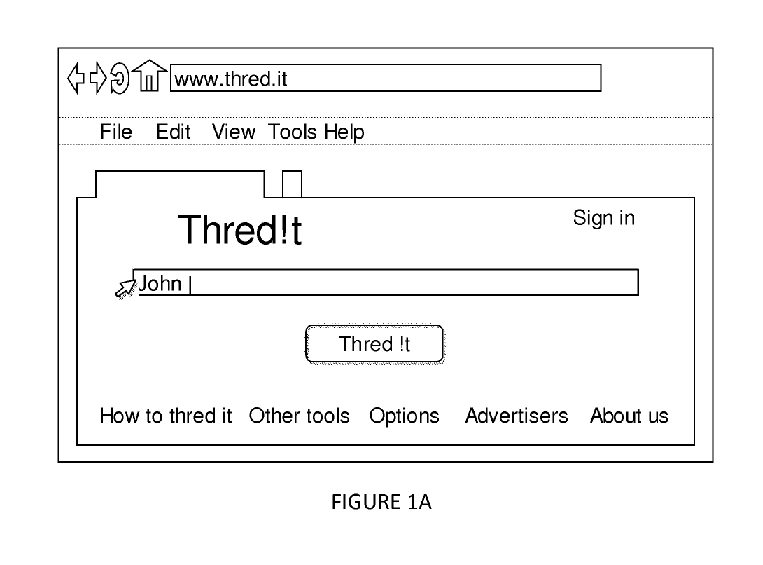

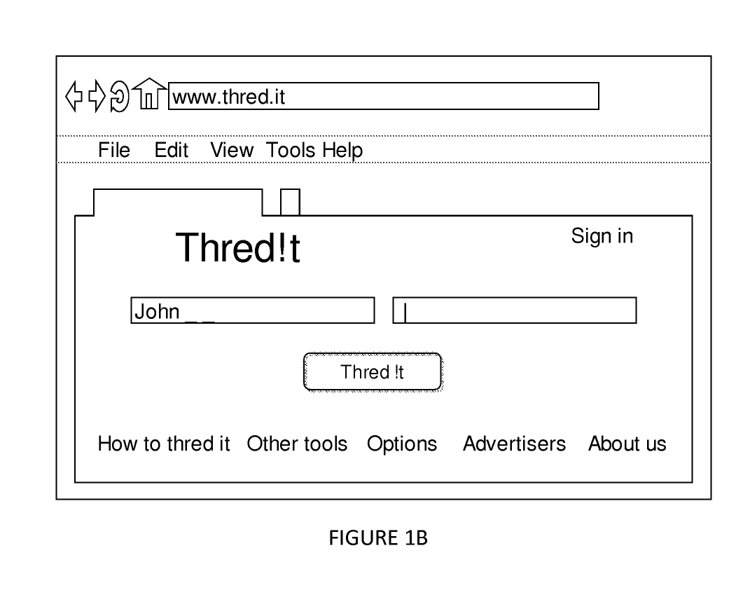

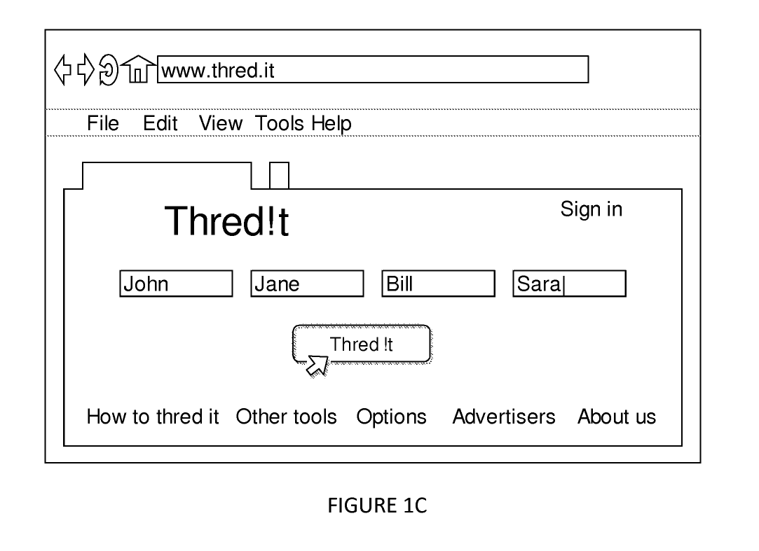

FIG. 1A shows how a search term can be entered into a search engine. Here, the search engine is accessible under the listing “www.thred.it” and a user has entered the search term “John.” When this search method is being used within a social network, online dating platform, or corporate employee directory it is understood that the search terms can be individual user profiles, or pre-selected or user defined groups of user profiles. As shown in FIG. 1B, the user keys in double space at the end of the first search term to split the search field into two fields. The cursor automatically moves to the new and second field so that a second search term can be entered. As shown in FIG. 1C, a user can enter a multitude of search terms by keying multiple double spaces between search terms. FIG. 1C shows four separate search terms have been entered which include John, Jane, Bill, and Sara.

The double space key stroke is commonly utilized as meaningful characters in type-written text, but is discarded by search engines as meaningless information. Therefore, the double space method provides users with the simplest, most familiar method of creating new search fields to match the number of search terms desired to be searched. It is understood by one skilled in the art that other keyboard shortcuts can be used to create new search fields and this disclosure is not limited to the precise form described herein.

The present invention requires at least two search terms be entered to then perform a search for a commonality or common thread. FIG. 6 is a block diagram of the method of using the present invention. The user enters the first input/search term in block 601. The user then keys in double space to create a new field in block 602. The user then enters a second input/search term in block 603. Block 604 asks whether there is another search term. If there are only two search terms, the user can then execute a search in block 607. If the user wants to add another additional term, the double space is keyed in again to create a third field in block 605. Then the user can enter in a new input term in block 606 which then leads back to block 604 which asks if another input term is desired. This process can be repeated to create a multitude of search terms.

The double space method described above to define new fields can be reversed to remove unwanted fields when the cursor is at the beginning of a successive field by striking the “backspace” key twice. It is to be understood by those skilled in the art that other keyboard shortcuts can be used to remove incremental search fields. When the user enters all the discrete terms between which the user desires to search for a common thread, the user, to execute the search can either strike the “enter” key, or press a search button. Again, it is to be understood by one skilled in the art that other methods of executing a search may be utilized.

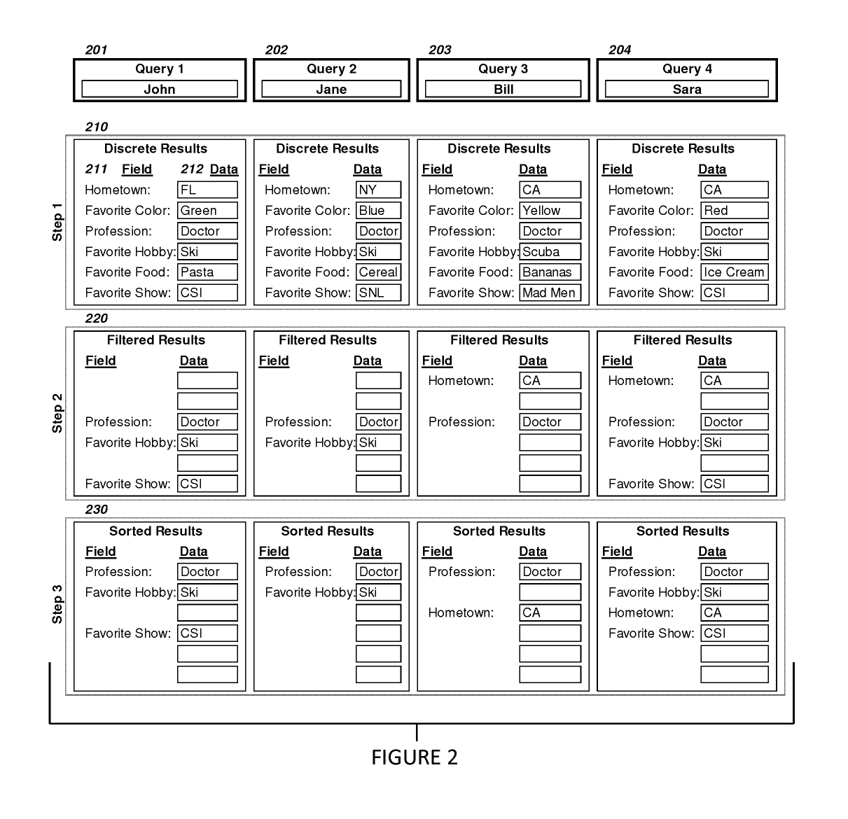

FIG. 2 is representational view of the logic used embodying the present invention based on the inputs from FIG. 1C of John, Jane, Bill, and Sara. The top row shows the inputs/search terms entered by the user of John 201, Jane 202, Bill 203, and Sara 204. Each search term is queried to independently retrieve all descriptive data fields referencing each search term. The results of those discrete searches in summarized in the second row 210 under Step 1. A common thread search can be done within two types of databases; Closed and Open Databases. A Closed Database with pre-defined fields includes a simple database, corporate directory, email server or social network. FIGS. 2 and 7 illustrate a common thread search between the four terms—John 201, Jane 202, Bill 203, and Sara 204. In this example, a search is being conducted within a database that stores six pre-defined fields of information for each entry including Hometown, Favorite Color, Profession, Favorite Hobby, Favorite Food, and Favorite Show. The data are then retrieved and shown in next to each pre-defined field in the second row 210.

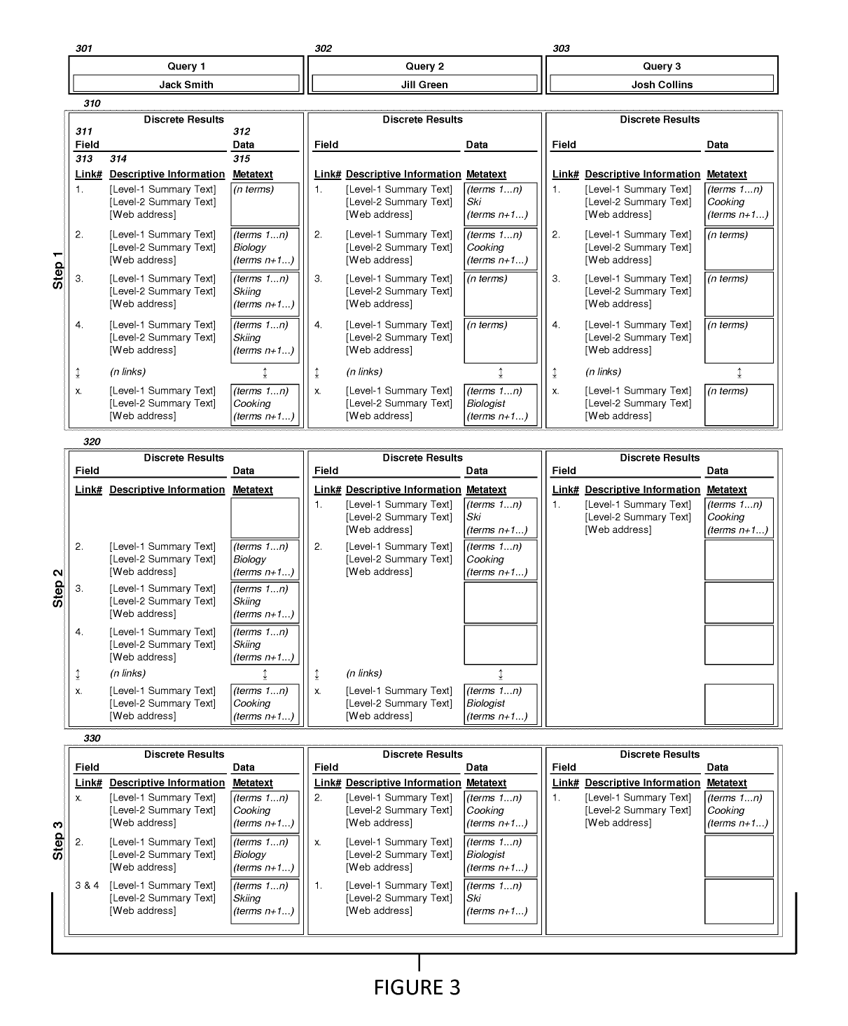

An Open Database has non-defined fields, such as the Internet, where there can be an unlimited number and type of entries. An Open Database can include a database or social network that allows user-defined fields, where there can be unlimited types of entries. FIGS. 3 and 8 represent searches performed within Open Databases and illustrate a common thread search between three terms—“Jack Smith” 301, “Jill Green” 302, and “Josh Collins” 303. In this example, the search is being conducted over the Internet, where there are nearly unlimited search results possible for each query. Discrete queries are made on any Internet search engine for each search term, and then stored. Each link result is considered a descriptive field, and that page's metatext becomes the descriptive data for that field. Search results may also be limited based on certain volume or relevancy thresholds if, as in the case of a broad Internet search, there can be millions of query results for each search term.

Referring to FIG. 3, the discrete search results are shown in row 310 entitled Step 1. The Field 311 and Data 312 then show results of Links 313 and the Descriptive Information 314 each like contains. The Metatext 315 is shown next to the Descriptive Information 314. Each discrete search result is shown for the three inputs of Jack Smith 301, Jill Green 302, and Josh Collins 303. It is to be understood by those skilled in the art that the configuration of the data searched and shown can be presented in a multitude of ways and methods and this disclosure is not limited to the precise form shown and described herein.

After discrete searches have been performed, the next step is to identify the common threads/commonalities and rank them in order of importance. As shown in FIG. 2 in the third row 220 entitled Step 2, if the search is within a Closed Database, then descriptive data fields not repeated across at least two search terms are removed. For instance, the Filtered Result for John 201 shows that his Profession is Doctor, his Favorite Hobby is to Ski, and his Favorite Show is CSI. These results are in common with either Jane 202, Bill 203, or Sara 204. Since all the descriptive data is limited to pre-defined keywords, a commonality search can be based on a simple keyword count. As shown in FIG. 2 in the fourth row 230 entitled step 3, the keywords repeated with the greatest frequency across the search terms are ranked highest. It is understood by one skilled in the art that any other standard measure of commonality can be used herein.

FIG. 7 is a block diagram of the method of using the present invention according to FIG. 2 showing how the discrete searches are performed and sorted within a Closed Database. Block 701 starts by performing a querry for all search terms. Block 702 then retrieves all fields and descriptive data from the database as independent search results. Then block 703 removes data not repeated between independent search results lists. Finally, block 704 sorts the fields based on commonality between all search term result lists.

Every web page has hidden descriptive identifiers, or metatext, that make it searchable to Internet search engines. FIG. 3 highlights the relevant metatext terms 315. In this embodiment, metatext is used to rank commonalities. Since the descriptive data in an Open Database search, such as that shown in FIG. 3 is not limited to pre-defined keywords, in other embodiments, common threads can be discovered from any part of a web page's information using natural language, lexical or other standard statistical methods. As shown in FIG. 3 row 320, if the search is within an Open Database metatext terms not repeated across at least two search terms are removed. For instance, Josh Collins 303 has only the discrete result left showing Cooking. Cooking is something found in common with either Jack Smith 301 or Jill Green 302. As shown in FIG. 3 in the fourth row 330 entitled step 3, the metatext repeated with the greatest frequency across the search terms are ranked highest. It is understood by one skilled in the art that any other standard measure of commonality can be used herein.

FIG. 8 is a block diagram of the method of using the present invention according to FIG. 3 showing how the discrete search can be performed within an Open Database, such as the Internet. Block 801 starts by performing a querry for all search terms. Block 802 retrieves x-number of search results as an independent search result list. This includes summary text and web links. Block 803 then removes the results that do not have at least one commonality with at least one search results from another independent search result list. Then block 804 sorts the fields based on commonality and link distance between all search term results lists. Block 805 groups fields in the same result list that have similar identified commonalities with other search result lists. Block 806 then asks the question whether there are more than y-number of commonality results. If so, then the results are stored. If not, then the process from 801 to 806 is repeated.

It is understood that common threads can be discovered, not only from metatext, but also from any part of a web page's information using natural language, lexical or other standard statistical methods. It is also understood that the terms used as the basis for a common thread need not be identical across queries. Similar terms can be considered a single thread. In FIG. 3 row 330 for example, “Biology” and “Biologist” are considered a single common thread. Similar words can be counted as the same commonality, as is done in FIG. 3 row 330 for links 3 and 4 which both share the commonality of “skiing.” The webpages with the most common metatext between search terms will be ranked the highest. However, commonly appearing words that are not typically informative (e.g., “the,” “and,” “but”) can be excluded.

Link distance may be used to further sort commonalities. Link distance is the number of links it would take to navigate from one page to another and can be used to further sort commonalities by determining how many degrees removed from an Indirect Commonality it is. Web pages that have shorter link distance between them are likely to represent a more meaningful commonality. Such an example of using link distance is described in the article, “Average-Clicks: A New Measure of Distance on the World Wide Web” by Yutaka Matsuo, Yukio Ohsawa, and Mitsuru Ishizuka, which is incorporated in full by reference herein.

For example when referring to FIG. 3, an Internet search for Jack Smith 301 and fill Green 302 reveals that fill is a biology teacher after discovering fill's school profile webpage at Link#x. Jack is found to be a biologist after discovering a research paper Jack published on the subject at Link#2. The initial discrete queries also find that Jack and Jill are both skiers. Jack is listed on two ski award pages for Big Mountain ski resort (Links#3 and 4 under Jack's initial results list), and fill is listed as winning a raffle at White Snow ski resort (Link#1 under fill's initial results list). In this example there are two Indirect Commonalities; Jack and Jill are both Biologists and skiers. No single web page made either of these commonalities explicit.

Furthermore, Jill posted an article on her profile page that links directly to Jack's research paper. Additionally, Jack's awards pages have links to Big Mountain's home page, which, in turn, has links to White Snow Resort's home page, which, in turn, has a link to fill's award page. Since it takes one link to get from Jill's school profile to Jack's research paper, and three links to get from Jack's ski awards pages to fill's ski raffle page, it is assumed that “Biologist” is a more relevant commonality than “Skiing,” and is therefore ranked higher, in block 330, notwithstanding the fact that the Ski link was the first, and therefore, most relevant result for fill in the discrete search. It is understood by one skilled in the art that other natural language and lexical measures of commonality can be used beyond link distance.

In another exemplary embodiment of the present invention, a user can also execute a hybrid search for commonalities with concurrent queries on both a Closed Database and Open Database. For example referring to FIG. 2, John 201 is a member of a social network, and his user profile is populated with the data for the various fields. John can use his profile to see what he has in common with entities on the Internet. John can, for example, add his user profile as an additional term in the Open Database search outlined in FIG. 3, to see what he has in common with someone on a social network such as Jack Smith 301, Jill Green 302, and Josh Collins 303.

In this example, a hybrid search would show that “Cooking” is the most common theme between the group as all four search queries return data related to cooking. “Cooking” metatext is independently identified in search results for Jack, Jill, and Josh and “Pasta” is a data field in John's user profile. The search would also show that Skiing is the next most common theme between the group, as John, Jack and Jill all ski.

In yet another exemplary embodiment of the present invention individual queries can be made for groups of people. For example John 201, Jane 202, Bill 203 and Sara 204 all belong to the same social network. They can be simply represented for searching purposes as the group 201-204.

Furthermore, in yet another exemplary embodiment, Jane 202, Bill 203, and Sara 204 can be members of a pre-defined group of doctors, called “The Practice,” within a broader social network. John 201 can search the common threads between himself and The Practice with just two queries: “John” and “The Practice”. The individual members of The Practice would be discretely queried and the rest of the search would be conducted as shown in FIG. 2. The results can be displayed as a group or broken out by individuals in additional columns.

In another exemplary embodiment of the present invention, a user can restrict commonality searches by adding commonalities as queries. These are called “Restriction Terms.” For example, in FIG. 2, a user can limit the commonality search to profession by adding the term “Profession” as an additional query. Adding this term would remove all the additional Fields 211 not related to Profession. In this example, the fields “Favorite Hobby,” “Favorite Show,” and “Hometown” would also have been removed. Alternatively, a user could add the term “Favorite” as an additional query. In this case, the fields “Profession” and “Hometown” would have been removed, allowing the user to see only commonalities relating to the Favorites. Furthermore, subsequent re-ranking methodologies such as those described above, can also be used.

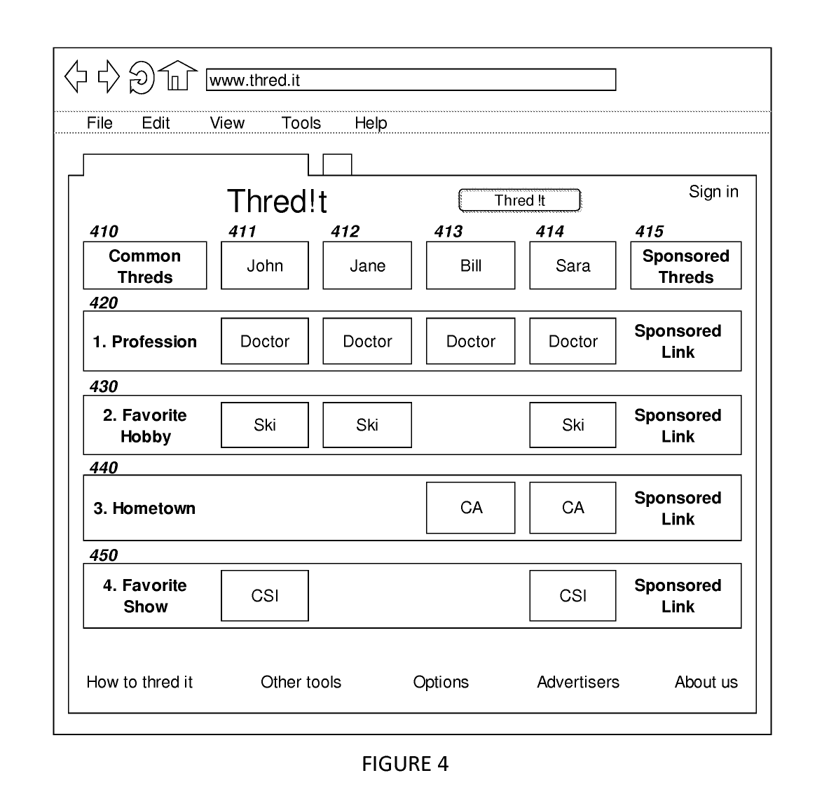

FIG. 4 is an exemplary search results of a Closed Database embodying the present invention based on the inputs from FIG. 2. The common threads 410 for John 411, Jane 412, Bill 413, and Sara 414 have been identified. The most relevant commonality/common thread 410 has been identified as Profession 420 which is Doctor. Doctor is a shared commonality between all four people. The second most relevant commonality/common thread 410 has been identified as Favorite Hobby 430 which is Ski. To Ski is shared by three of the four people. The next commonality/common thread 410 is Hometown 440 which is California and Favorite Show 450 which is CSI. These were commonalities 410 were shared by two of the four people.

As can be seen, each search term (John 411, Jane 412, Bill 413, Sara 414) is a column header. Commonalities 410 are grouped together in rows underneath the column headers. Each commonality 410 is called a Thread or Thread Box. Each Thread is labeled according to its corresponding commonality to the left of the Thread Box. The relevant common keywords, or as in the case of an Internet search, the metatext from each discrete search result is highlighted within the Thread Box underneath its respective search term. In the case of Open Database search, degrees of separation between individual common links can also be displayed in each Thread Box. Alternatively, it is understood by one skilled in the art that the graphical representations of commonalities can be used instead of text in each Thread Box. For example, in Box 450, a graphical representation of the show CSI can be used instead of, or alongside, the text to make it easier for users to navigate commonalities visually.

Alternatively, in a different embodiment columns could also represent groups of entities. For example in the previous example where John 201 searches The Practice, the results for Jane 202, Bill 203, and Sara 204, which are summarized individually in FIG. 4 (412-414), could instead be summarized as one column under the heading, “The Practice.” Alternatively, columns could also be hidden if, for example, one of the search terms was intended to be used as a Restriction Term.

Alternatively, in a different embodiment columns could also represent the most highly ranked commonalities. This will allow the entities that share the commonality to be aggregated under each commonality. For example in FIG. 4, The Favorite Hobby “Skiing” can be shown at the top of the page, and “John,” “Jane,” and “Sara” will be shown underneath. This will allow users to quickly see which subsets of the group belong to various commonalities.

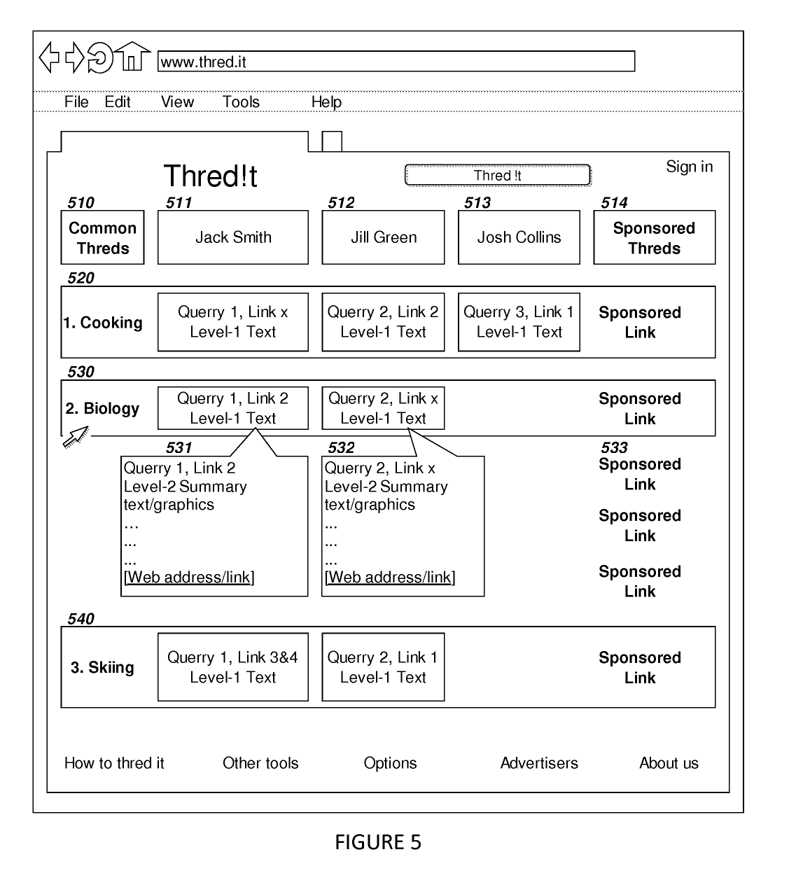

FIG. 5 is an exemplary search result of an Open Database embodying the present invention associated with inputs of FIG. 3. The common threads 510 are shown in rows 520 for Cooking, row 530 for Biology, and row 540 for Skiing. The column headers are shown as Jack Smith 511, Jill Green 512, and Josh Collins 513. The most relevant common thread 510, discovered in FIG. 3 block 330, was Cooking 520 and is listed first. The second most common thread 510, discovered in FIG. 3 block 330, was Biology 530. Each result box contains a link to the web address where the commonality was identified. For instance, link information 531 and 532 can be accessed/opened to display and take the user to where the information was found.

When navigating the results of either FIG. 4 or 5, the user can scroll up and down the page to view the initial common threads results list. To gain additional detail on the Thread a user can double click on a specific Thread Box to expand the Thread. Expanding the thread (530, 904) will show additional summary text (531, 532, 905) from each common data entry highlighted, or as in the case of an internet search, the relevant metatext or summary web page text. For an Internet search, once a Thread is expanded, the user can now click individual links in order to navigate those respective web pages directly.

A user can also re-sort the information found. Users can click and drag Threads by selecting an individual Thread Box and dragging it higher or lower in the results list. This information can be used to inform future searches. Alternatively, users can click and drag a Thread Box off the page to remove that commonality from the search entirely. Re-sorting a Thread, removing a Thread, and obtaining new user input can all be used to inform future searches such that undesirable Threads are not repeatedly displayed. For instance, once a commonality search has been performed, a subsequent input from the user can be used to inform future commonality searches.

Existing advertising sales placement technologies do not allow advertisers to bid for or buy advertisements for commonalities on a one-to-one basis. Existing advertising sales placement technology currently uses various forms of commonality measures to sell a plurality of advertisements against one search results list. For example, a plurality of advertisers buying a plurality of keyword commonalities will be sponsoring a single search result list. An exemplary embodiment of the present invention allows advertisers to bid for the exclusive sponsorship of discrete commonalities. The present invention is a more attractive advertising platform than traditional search technologies because users of this technology may be inherently more open to clicking on a sponsored link. Since users of traditional search engines must have an idea of what they are searching for prior to the execution of their search, they are more focused, and thus, less likely to invite a sponsored link or advertisement. By comparison, users of this technology can not have a preconceived notion of what they are searching for. As such, they may be relatively open to viewing sponsored results, which may help offer the user more relevant information relating newly revealed common threads.

The present invention is also a convenient and direct way to provide Online Advertising as shown in FIGS. 4, 5, and 9. As can be seen in FIGS. 4 and 5, an additional column is added to the right of the search term headers called Sponsored Threads 415, 514. A space is created within, and on the right side of each Thread Box for a single sponsored link that is relevant to that thread. Because the commonality is explicitly defined within each thread, standard ad placement technologies in the related art can be used herein. For example, advertisers must typically buy many keywords to increase the confidence their advertisement is being placed in the right context. Advertisers risk that their link is ignored because there are many advertisements for any given keyword. Here, the advertiser can buy a single keyword and be the only advertiser for a single common thread. In FIG. 5, advertisers bid on the keyword “Cooking”. The highest bidder receives the sponsored link in that Thred Box 520. When a user is navigating the results and a particular Thread is expanded 530, 904 it implies elevated interest in that commonality, and hence more value to a potential advertiser. The additional space on the right side of the expanded Thread Box can be used to place additional advertisements or sponsored links that are relevant to the Thread 533, 906. In a Closed Database search, as highlighted in FIG. 4, the commonality results themselves can be used as sponsored links. For example, in Box 450, “CSI” is John and Sara's favorite show. Instead of placing the text “CSI”, an online video distributor partner can be pooled for a representative graphic of the show with a link to that video distributor's website. A referral fee can be received when a user clicks on the CSI graphic, and is taken to the online video distributor's site.

FIG. 9 is a block diagram of the method of using the present invention featuring advertisements. Block 901 starts by populating the Thread Box with the highest ranked commonality and provides summary test from each respective search term result. In block 902, advertisers bid for the individual keyword commonality. The highest bidding advertiser receives sole placement in the Thread Box. In block 903, if there are more commonality results the process is repeated back to block 901. If not, then the user can click on a thread box in block 904. Block 905 reveals a level-2 summary test and web link for each search term result relating to that common thread. Finally, at block 906 the highest bidder for the relevant Thread Box/common thread is obtained and the associated sponsored ad or link is placed in order of bid price.

In an exemplary embodiment of the present invention, a computer implemented method of finding commonalities among search terms within an electronic database, comprises the steps of: receiving, via a computing device, at least two search terms from a user; performing, via the computing device, an individual computerized search within the electronic database for each of the at least two search terms; generating, via the computing device, a plurality of individual results for each of the at least two search terms; identifying, via the computing device, at least one commonality mutually shared by at least two of the plurality of individual results; and presenting, via the computing device, to the user the at least one commonality. The exemplary embodiment may further comprise the step of removing all individual results from the plurality of individual results lacking the at least one commonality. The computing device can include a search engine accessible via the Internet from a browser application on a computer or work station. Alternatively, the computing device can also include a computer searching through a local closed database.

The electronic database can comprise a closed or open database. The closed database limits user entries to pre-defined fields and can include a local database, an email server, a corporate directory, a closed social network, a research database, or an intranet. The open database allows user-defined fields and can include the Internet or an open social network. Furthermore, the electronic database can comprise both an open database and a closed database.

An exemplary embodiment can further comprise the step of excluding all non-informative commonalities from the at least one commonality. For example, non-informative commonalities can include, but are not limited to, the words, “the,” “and,” and “but.” These words do not add any context or information to the search and should be excluded as commonalities.

The at least one commonality can comprise a plurality of commonalities. Furthermore, an exemplary embodiment can comprise the step of ranking the plurality of commonalities. The ranking the plurality of commonalities can be based on the number of search terms with which the commonality is associated, where the commonality associated with the greatest number of search terms is ranked highest. The ranking the plurality of commonalities can be further based on a frequency of the commonality across all individual results, where the commonality repeated with the greatest frequency is ranked highest. The ranking the plurality of commonalities can be further based on a link distance—the number of links it takes to navigate from one web page to another—where the commonality with the smallest link distance is ranked highest.

In another exemplary embodiment, the step of presenting the at least one commonality to the user comprises displaying each of the at least two search terms as column headers. Presenting the at least one commonality to the user can further comprise displaying each of the at least one commonality as row headers.

Another exemplary embodiment can comprise receiving an additional search term from a user after a first predetermined keyboard shortcut to benefit user convenience and search efficiency. The first predetermined keyboard shortcut can comprise a double space. Furthermore, an exemplary embodiment can comprise the step of removing the additional search term after a second predetermined keyboard shortcut. The second predetermined keyboard shortcut can comprise a double backspace.

In another exemplary embodiment the database can comprise the Internet wherein the plurality of individual results for each of the at least two search terms can comprise hidden descriptive identifiers. The hidden descriptive identifiers can comprise metatext. Furthermore, an exemplary embodiment can comprise the step of ranking the plurality of commonalities from the individual results based on the metatext, where the metatext repeated with the greatest frequency is ranked highest. The presenting step can further comprise providing information associated with the at least one commonality including an accessible web address, or other web page summary text.

In another exemplary embodiment, the at least one of the at least two search terms can be a predefined group.

Another exemplary embodiment can further comprise the step of removing a particular commonality from the plurality of commonalities, the removed commonality corresponding to a user-defined restriction term.

Another exemplary embodiment can further comprise the step of re-sorting the ranking of the plurality of commonalities based upon a manual re-sorting of the rankings by the user. The user can manually re-sort the rankings by dragging a particular commonality higher or lower in ranking.

Another exemplary embodiment can further comprise the step of manually removing a particular commonality from the plurality of commonalities.

Another exemplary embodiment can further comprise the step of providing a sponsored advertisement associated with the at least one commonality. The sponsored advertisement can be determined by the highest bidder. Relevant advertisements can be placed along side each commonality, or group of commonalities or the commonalities can themselves contain links to sponsored advertisements.

In yet another exemplary embodiment of the present invention, a computer-readable medium having computer-readable instructions stored thereon which, which executed by a computer, can cause the computer to perform a method of finding commonalities among search terms within an electronic database. The steps comprise: receiving, through the computer, at least two search terms from a user; performing, through the computer, an individual computerized search within an electronic database for each of the at least two search terms; generating, through the computer, a plurality of individual results for each of the at least two search terms; identifying, through the computer, at least one commonality mutually shared by at least two of the plurality of individual results; and presenting, through the computer, to the user the at least one commonality.

In another exemplary embodiment, the at least one commonality can comprise a plurality of commonalities. The plurality of commonalities can be ranked. The step of ranking the plurality of commonalities can based on the number of search terms with which the commonality is associated, where the commonality associated with the greatest number of search terms is ranked highest. The step of ranking the plurality of commonalities is further based on a frequency of the commonality across all individual results, where the commonality repeated with the greatest frequency is ranked highest. The step of ranking the plurality of commonalities is further based on a link distance, where the commonality with the smallest link distance is ranked highest. An exemplary embodiment can further comprise the step of removing a particular commonality from the plurality of commonalities, the removed commonality corresponding to a user-defined restriction term.

In yet another exemplary embodiment of the present invention, a computing device can be configured to perform operations. The operations can comprise: receiving, through the computing device, at least two search terms from a user; performing, through the computing device, an individual computerized search within an electronic database for each of the at least two search terms; generating, through the computing device, a plurality of individual results for each of the at least two search terms; identifying, through the computing device, a plurality of commonalities mutually shared by at least two of the plurality of individual results; and presenting, through the computing device, to the user the at least one commonality.

An exemplary embodiment can further comprise ranking, through the computing device, the plurality of commonalities wherein the ranking the plurality of commonalities is based on the number of search terms with which the commonality is associated, where the commonality associated with the greatest number of search terms is ranked highest. The ranking the plurality of commonalities can be further based on a frequency of the commonality across all individual results, where the commonality repeated with the greatest frequency is ranked highest. The ranking the plurality of commonalities can be further based on a link distance, where the commonality with the smallest link distance is ranked highest. The ranking the plurality of commonalities can be further based on other standard measures of commonality, including natural language, lexical or other statistical methods. An exemplary embodiment can further comprise removing, through the computing device, a particular commonality from the plurality of commonalities wherein the removed commonality corresponds to a user-defined restriction term.

Although several embodiments have been described in detail for purposes of illustration, various modifications may be made to each without departing from the scope and spirit of the invention. Accordingly, the invention is not to be limited, except as by the appended claims.

What is claimed is:

1. A computer implemented method of finding commonalities among search terms within an electronic database, comprising the steps of:
receiving, via a computing device, at least two search terms from a user;
performing, via the computing device, an individual computerized search within the electronic database for each of the at least two search terms;
generating, via the computing device, a plurality of individual results for each of the at least two search terms;
identifying, via the computing device, at least one commonality mutually shared by at least two of the plurality of individual results; and
presenting, via the computing device, to the user the at least one commonality.

2. The computer implemented method of claim 1, further comprising the step of removing, via the computing device, all individual results from the plurality of individual results lacking the at least one commonality.

3. The computer implemented method of claim 1, wherein the electronic database comprises a closed database.

4. The computer implemented method of claim 3, wherein the closed database includes a local database, an email server, a corporate directory, a closed social network, a research database, or an intranet.

5. The computer implemented method of claim 1, wherein the electronic database comprises an open database.

6. The computer implemented method of claim 5, wherein the open database includes the Internet or an open social network.

7. The computer implemented method of claim 1, wherein the electronic database comprises both an open database and a closed database.

8. The computer implemented method of claim 1, further comprising the step of excluding, via the computing device, all non-informative commonalities from the at least one commonality.

9. The computer implemented method of claim 1, wherein the at least one commonality comprises a plurality of commonalities.

10. The computer implemented method of claim 9, further comprising the step of ranking, via the computing device, the plurality of commonalities.

11. The computer implemented method of claim 10, wherein the step of ranking the plurality of commonalities is based on the number of search terms with which the commonality is associated, where the commonality associated with the greatest number of search terms is ranked highest.

12. The computer implemented method of claim 11, wherein the step of ranking the plurality of commonalities is further based on a frequency of the commonality across all individual results, where the commonality repeated with the greatest frequency is ranked highest.

13. The computer implemented method of claim 12, wherein the step of ranking the plurality of commonalities is further based on a link distance, where the commonality with the smallest link distance is ranked highest.

14. The computer implemented method of claim 1, wherein the step of presenting the at least one commonality to the user comprises displaying each of the at least two search terms as column headers.

15. The computer implemented method of claim 14, wherein the step of presenting the at least one commonality to the user further comprises displaying each of the at least one commonality as row headers.

16. The computer implemented method of claim 15, wherein the step of presenting the at least one commonality to the user further comprises displaying each of the plurality of individual results below its corresponding column header and adjacent to its corresponding row header.

17. The computer implemented method of claim 1, further comprising the step of receiving an additional search term from a user after a first predetermined keyboard shortcut.

18. The computer implemented method of claim 17, wherein the first predetermined keyboard shortcut comprises a double space.

19. The computer implemented method of claim 18, further comprising the step of removing the additional search term after a second predetermined keyboard shortcut.

20. The computer implemented method of claim 19, wherein the second predetermined keyboard shortcut comprises a double backspace.

21. The computer implemented method of claim 9, wherein the database comprises the Internet and wherein the plurality of individual results for each of the at least two search terms comprise hidden descriptive identifiers.

22. The computer implemented method of claim 21, wherein the hidden descriptive identifiers comprise metatext.

23. The computer implemented method of claim 22, further comprising the step of ranking, via the computing device, the plurality of commonalities from the individual results based on the metatext, where the metatext repeated with the greatest frequency is ranked highest.

24. The computer implemented method of claim 1, wherein the presenting step further comprises providing information associated with the at least one commonality including an accessible web address.

25. The computer implemented method of claim 1, wherein the presenting step further comprises providing graphical representations of commonalities.

26. The computer implemented method of claim 1, wherein at least one of the at least two search terms is a predefined group.

27. The computer implemented method of claim 9, further comprising the step of removing, via the computing device, a particular commonality from the plurality of commonalities, the removed commonality corresponding to a user-defined restriction term.

28. The computer implemented method of claim 10, further comprising the step of re-sorting the ranking of the plurality of commonalities based upon a manual re-sorting of the rankings by the user.

29. The computer implemented method of claim 28, wherein the user can manually re-sort the rankings by dragging a particular commonality higher or lower in ranking.

30. The computer implemented method of claim 9, further comprising the step of manually removing a particular commonality from the plurality of commonalities.

31. The computer implemented method of claim 30, further comprising the step of receiving, via the computing device, a subsequent input from the user for a future commonality search.

32. The computer implemented method of claim 1, further comprising the step of providing a sponsored advertisement or product placement associated with the at least one commonality or a group of commonalities.

33. The computer implemented method of claim 32, wherein the sponsored advertisement or product placement is determined by the highest bidder.

34. A computer-readable medium having computer-readable instructions stored thereon which, which executed by a computer, cause the computer to perform a method of finding commonalities among search terms within an electronic database, comprising the steps of:
receiving, through the computer, at least two search terms from a user;
performing, through the computer, an individual computerized search within an electronic database for each of the at least two search terms;
generating, through the computer, a plurality of individual results for each of the at least two search terms;
identifying, through the computer, at least one commonality mutually shared by at least two of the plurality of individual results; and
presenting, through the computer, to the user the at least one commonality.

35. The computer-readable medium of claim 34, wherein the at least one commonality comprises a plurality of commonalities.

36. The computer-readable medium of claim 35, further comprising the step of ranking the plurality of commonalities.

37. The computer-readable medium of claim 36, wherein the step of ranking the plurality of commonalities is based on the number of search terms with which the commonality is associated, where the commonality associated with the greatest number of search terms is ranked highest.

38. The computer-readable medium of claim 37, wherein the step of ranking the plurality of commonalities is further based on a frequency of the commonality across all individual results, where the commonality repeated with the greatest frequency is ranked highest.

39. The computer-readable medium of claim 38, wherein the step of ranking the plurality of commonalities is further based on a link distance, where the commonality with the smallest link distance is ranked highest.

40. The computer-readable medium of claim 39, further comprising the step of removing a particular commonality from the plurality of commonalities, the removed commonality corresponding to a user-defined restriction term.

41. A computing device configured to perform operations comprising:
receiving, through the computing device, at least two search terms from a user;
performing, through the computing device, an individual computerized search within an electronic database for each of the at least two search terms;
generating, through the computing device, a plurality of individual results for each of the at least two search terms;
identifying, through the computing device, a plurality of commonalities mutually shared by at least two of the plurality of individual results; and
presenting, through the computing device, to the user the at least one commonality.

42. The computing device of claim 41, further comprising ranking, through the computing device, the plurality of commonalities wherein the ranking the plurality of commonalities is based on the number of search terms with which the commonality is associated, where the commonality associated with the greatest number of search terms is ranked highest.

43. The computing device of claim 42, wherein the ranking the plurality of commonalities is further based on a frequency of the commonality across all individual results, where the commonality repeated with the greatest frequency is ranked highest.

44. The computing device of claim 43, wherein the ranking the plurality of commonalities is further based on a link distance, where the commonality with the smallest link distance is ranked highest.

45. The computing device of claim 44, further comprising removing, through the computing device, a particular commonality from the plurality of commonalities wherein the removed commonality corresponds to a user-defined restriction term.
